(19) United States
(12) Patent Application Publication
(10) Pub. No.: US 2024/0004667 A1
(43) Pub. Date: Jan. 4, 2024

(54) PARALLEL PROCESSING DEVICE

(71) Applicant: MORUMI CO., LTD., Seongnam-si (KR)

(72) Inventor: Tae Hyoung KIM, Seongnam-si (KR)

(73) Assignee: MORUMI CO., LTD., Seongnam-si (KR)

(21) Appl. No.: 18/369,532

(22) Filed: Sep. 18, 2023

Related U.S. Application Data
(63) Continuation-in-part of application No. PCT/KR2022/003672, filed on Mar. 16, 2022.

(30) Foreign Application Priority Data
Mar. 17, 2021 (KR) 10-2021-0034494

(51) Int. Cl. G06F 9/38; G06F 9/50

(52) U.S. Cl. CPC G06F 9/3895; G06F 9/5027

(57) ABSTRACT

A parallel processing device includes a preprocessing part comprising preprocessing units and a main processing part comprising summers. Each of the preprocessing units comprises a selection operator and a shift operator. The selection operator is configured to operate when corresponding one of the preprocessing units operates in a summing mode, and configured to perform a function of transmitting corresponding some first signals of first signals to corresponding one of the summers according to bits of corresponding one of second signals respectively. The shift operator is configured to operate when the corresponding preprocessing unit operates in a multiplication mode, and configured to transmit signals resulting from shifting corresponding one of the first signals to the corresponding summer according to the bits respectively.

### CROSS-REFERENCE TO PRIOR APPLICATIONS

This Application is a Continuation-in-Part of PCT International Application No. PCT/KR2022/003672 (filed on Mar. 16, 2022), which claims priority to Korean Patent Application No. 10-2021-0034494 (filed on Mar. 17, 2021), which are all hereby incorporated by reference in their entirety.

### BACKGROUND

The present disclosure relates to a parallel processing device.

Research on parallel processing devices has been widely conducted for high data processing performance. As an example of a parallel processing device, there is a multi-core processor. The multi-core processor is a processor equipped with a plurality of cores (processing units). The reason for using the multi-core processor is to improve the overall performance of the processor by increasing the number of cores. However, for various reasons, increasing the number of cores does not necessarily result in a proportional increase in the overall performance of the processor.

To solve this problem, the inventor of the present disclosure has been continuously carrying out continuous development, and proposed Korean Patent Application Publications No. 10-2019-0132295, No. 10-2018-0057950, No. 10-2018-0058166, No. 10-2018-0058167, No. 10-2018-0007523, and No. 10-2018-0007652 and Korean Patent No. 10-1859294.

### SUMMARY

A parallel processing device in the related art has summer and multipliers separately. This reduces the efficiency of the parallel processing device. More specifically, when many multiplication operations are required, all the multipliers of the parallel processing device are used, but some of the summers are not used. In addition, when many sum operations are required, all the summers of the parallel processing device are used, but some of the multipliers are not used. In addition, the parallel processing device in the related art has an aspect in which data exchange between processing units is difficult. This reduces the overall performance of the parallel processing device.

The present disclosure has been made keeping in mind the above problems occurring in the related art, and the present disclosure is directed to increasing the efficiency of a parallel processing device by designing processing units of the parallel processing device to be capable of performing multiplication operations and sum operations. In addition, the present disclosure is directed to increasing the overall efficiency of the parallel processing device by facilitating data exchange between the processing units. In addition, the present disclosure is directed to increasing the overall efficiency of the parallel processing device by allowing each processing unit to perform various operations over time. In addition, the present disclosure is directed to not increase the overall hardware complexity significantly despite having the above-described improvements.

According to an embodiment, there is provided a parallel processing device that receives first to N-th inputs {X1, Y1}, {X2, Y2}, . . . , and {XN, YN} and outputs first to N-th outputs M1, M2, . . . , and MN. The first to N-th inputs {X1, Y1}, {X2, Y2}, . . . , and {XN, YN} include a plurality of first signals X1, X2, . . . , and XN and a plurality of second signals Y1, Y2, and YN, and the N is a natural number of 4 or more. The parallel processing device includes: a preprocessing part configured to transmit an i-th first signal Xi to each summer SUM1, SUM2, . . . , and SUMN according to i-th bits Y1[i], Y2[i], . . . , and YN[i] of the plurality of second signals Y1, Y2, . . . , and YN when operating in a summing mode, or respectively transmit signals (X1<<(i-1)), (X2<<(i-1)), . . . , and (XN<<(i-1)) resulting from shifting the first signals X1, X2, . . . , and XN by (i-1) bits to the summers SUM1, SUM2, . . . , and SUMN according to the i-th bits Y1[i], Y2[i], . . . , and YN[i] of the second signals Y1, Y2, . . . , and YN when operating in a multiplication mode, wherein the i is a natural number that is equal to or greater than 1 and is equal to or less than the N; and a main processing part including the summers SUM1, SUM2, . . . , and SUMN configured to output the first to N-th outputs M1, M2, . . . , and MN, wherein each of the summers SUM1, SUM2, . . . , and SUMN adds the transmitted signals.

According to an embodiment, there is provided a parallel processing device including: a preprocessing part including preprocessing units; and a main processing part including summers, wherein each of the preprocessing units includes a selection operator and a shift operator, and the selection operator is configured to operate when corresponding one of the preprocessing units operates in a summing mode, and configured to perform a function of transmitting first signals to corresponding one of the summers according to bits of corresponding one of second signals respectively, and the shift operator is configured to operate when the corresponding preprocessing unit operates in a multiplication mode, and configured to transmit signals resulting from shifting corresponding one of the first signals to the corresponding summer according to the bits respectively.

According to an embodiment, there is provided a parallel processing device including: a preprocessing part including preprocessing units; and a main processing part including summers, wherein each of the preprocessing units includes a selection operator and a shift operator, and the selection operator is configured to operate when corresponding one of the preprocessing units operates in a summing mode, and configured to perform a function of transmitting corresponding some first signals of first signals to corresponding one of the summers according to bits of corresponding one of second signals respectively, and the shift operator is configured to operate when the corresponding preprocessing unit operates in a multiplication mode, and configured to transmit signals resulting from shifting corresponding one of the first signals to the corresponding summer according to the bits respectively.

The parallel processing device according to the present disclosure has high efficiency of parallel processing because a basic unit is capable of performing both a multiplication operation and a sum operation. In addition, the parallel processing device can additionally perform a displacement operation and a shift operation.

In addition, the parallel processing device enables easy data exchange between the processing units. In addition, in the parallel processing device, each processing unit can perform various operations over time. In addition, despite the above-mentioned improvements, the parallel processing device does not have significantly increased hardware complexity.

### BRIEF DESCRIPTION or TEE DRAWINGS

FIG. 1 is a diagram illustrating a parallel processing device according to a first embodiment.

FIG. 2 is a diagram illustrating an example of an i-th preprocessing unit according to the first embodiment.

FIG. 3 is a diagram illustrating a parallel processing device according to a second embodiment.

### DETAILED DESCRIPTION

A variety of modifications may be made to the present disclosure and there are various embodiments of the present disclosure, particular embodiments of the present disclosure are illustrated in the drawings and will be described in detail. However, the present disclosure is not limited thereto, and the exemplary embodiments can be construed as including all modifications, equivalents, or substitutes in a technical concept and a technical scope of the present disclosure.

Terms “first”, “second”, “A”, “B”, etc. can be used to describe various elements, but the elements are not to be construed as being limited to the terms. The terms are only used to differentiate one element from the other elements. For example, the “first” element may be named the “second” element without departing from the scope of the present disclosure, and the “second” element may also be similarly named the “first” element. The term “and/or” includes a combination of a plurality of items or any one of a plurality of terms.

In the terms used herein, an expression used in the singular encompasses the expression of the plural, unless the context clearly means otherwise. It will be furthermore understood that the terms “comprises”, “comprising”, “includes”, and “including” specify the presence of stated features, numbers, steps, operations, elements, components, or combinations thereof, but do not preclude the presence or addition of one or more other features, numbers, steps, operations, elements, components, or combinations thereof.

Before providing a detailed description of the drawings, it would be clarified that the division of elements in the present disclosure is merely a division according to main functions each element is responsible for. That is, two or more elements, which will be described below, may be combined into one element, or one element may be divided into two or more parts for more detailed functions. In addition to the main functions that each element is responsible for, each of the elements may additionally perform some or all of the functions that the other elements are responsible for. Some of main functions each element is responsible for may be handled and performed by the other elements.

In addition, in performing a method or an operation method, steps constituting the method may occur in an order different from an order described herein unless a specific order is clearly stated in context. In other words, the steps may be performed in the same order as described, may be performed substantially simultaneously, or may be performed in the reverse order.

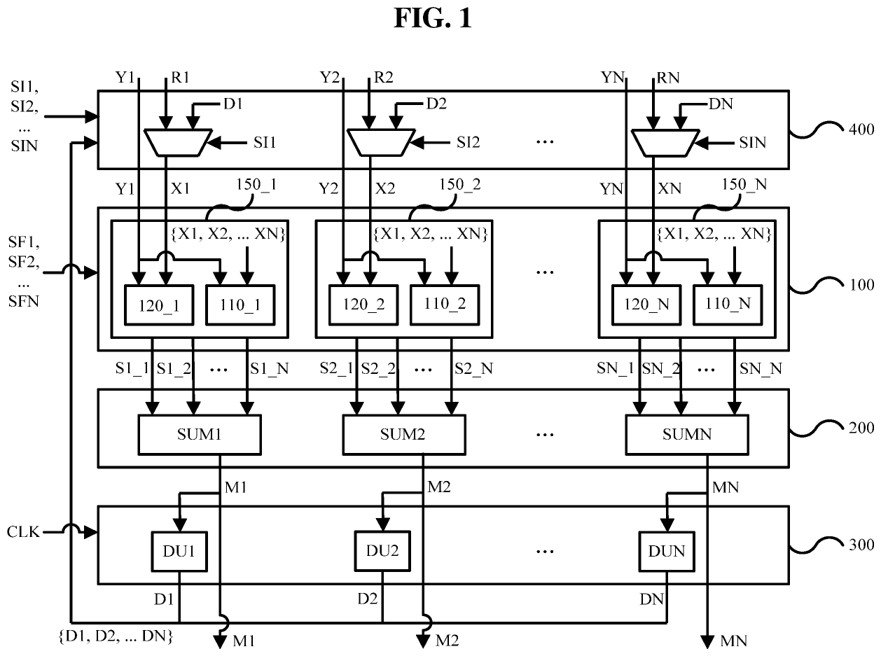

FIG. 1 is a diagram illustrating a parallel processing device according to a first embodiment. Referring to FIG. 1, the parallel processing device receives first to N-th inputs {X1, Y1}, {X2, Y2}, . . . , and {XN, YN} and outputs first to N-th outputs M1, M2, and MN. Herein, N means a natural number of 4 or more, and for example, N may be 32. The first to N-th inputs {X1, Y1}, {X2, Y2}, . . . , and {XN, YN} include first signals X1, X2, . . . , and XN and second signals Y1, Y2, . . . , and YN. The parallel processing device includes a preprocessing part 100 and a main processing part 200. The parallel processing device may further include a delay part 300 and a selection part 400.

When the preprocessing part 100 operates in a summing mode, the first signal Xi of the i-th input {Xi, Yi} is transmitted to each summer SUM1, SUM2, . . . , and SUMN of the main processing part 200 according to the i-th bits Y1[i], Y2[i], . . . , and YN[i] of the second signals Y1, Y2, . . . , and YN. Herein, i is a natural number that is equal to or greater than 1 and is equal to or less than N. Assuming that the inputs of a first summer SUM1 are S1_1, S1_2, . . . , and S1_N, the inputs of a second summer SUM2 are S2_1, S2_2, . . . , and S2_N, and the inputs of a third summer SUM3 are S3_1, S3_2, . . . , and S3_N. Herein, the summing mode operation of the preprocessing part 100 may be expressed in Verilog language as follows, for example.

(Y1[1] ? Xi: 0)=>S1_1,

(Y1[2] ? X2: 0)=>S1_2,

. . .

(Y1 [N] ? XN: 0)=>S1_N,

(Y2[1] ? X1: 0)=>S2_1,

(Y2[2] ? X2: 0)=>S2_2,

. . .

(Y2 [N] ? XN: 0)=>S2_N,

. . .

(YN[1] ? X1: 0)=>SN_1,

(YN[2] ? X2: 0)=>SN_2,

. . .

(YN[N] ? XN: 0)=>SN_N

When the preprocessing part 100 operates in a multiplication mode, signals (X1<<(i-1)), (X2<<(i-1)), . . . , and (XN<<(i-i)), which result from shifting the first signals X1, X2, . . . , and XN by i-1 bit, are respectively transmitted to the summers SUM1, SUM2, . . . , and SUMN according to the i-th bits Y1[i], Y2[i], . . . , and YN[i] of the second signals Y1, Y2, . . . , and YN. The multiplication mode operation of the preprocessing part 100 may be expressed in Verilog language as follows, for example.

(Y1[1] ? (X1<<0): 0)=>S1_1,

(Y1[2]? (X1<<1): 0)=>S1_2,

. . .

(Y1[N] ? (X1<<(N-1)): 0)=>S1_N,

(Y2[1] ? (X2<<0): 0)=>S2_i,

(Y2[2] ? (X2<<1): 0)=>S2_2,

. . .

(Y2 [N] ? (X2<<(N-1)): 0)=>S2_N,

. . .

(YN[1] ? (XN<<0): 0)=>SN_i,

(YN[2] ? (XN<<1): 0)=>SN_2,

. . .

(YN[N] ? (XN<<(N-1)): 0)=>SN_N

For example, according to operation mode selection signals SF1, SF2, . . . , and SFN, the preprocessing part 100 operates in the summing mode or the multiplication mode. For example, one operation mode selection signal may be allocated to the entire parallel processing device. In this case, the entire parallel processing device operates in the summing mode or the multiplication mode. As another example, N operation mode selection signals SF1, SF2, . . . , and SFN may be allocated. In this case, some of the N outputs M1, M2, . . . , and MN may be set to be results obtained according to the summing mode and the others may be set to be results obtained according to the multiplication mode. For example, when N is 4, the operation mode selection signals SF1, SF2, SF3, and SF4 may be set such that M1, M2, and M3 operate in the multiplication mode and the M4 operates in the summing mode.

For example, the preprocessing part 100 includes a plurality of preprocessing units 150_1, 150_2, . . . , and 150_N. The plurality of preprocessing units 150_1, 150_2, . . . , and 150_N include selection operators 110_1, 110_2, . . . , and 110_N and shift operators 120_1, 120_2, . . . , and 120_N. The preprocessing unit 150_i includes the selection operator 110_i and the shift operator 120_i.

The selection operator 110_i operates when the preprocessing unit 150_i operates in the summing mode. The selection operator 110_i performs a function of transmitting the first signals X1, X2, . . . , and XN to the summer SUMi according to the bits Yi[1], Yi[2], . . . , and Yi[N] of the second signal Yi. Herein, the operation of the selection operator 110_i may be expressed in Verilog language as follows, for example.

(Yi[1] ? X1: 0)=>Si_1,

(Yi[2] ? X2: 0)=>Si_2,

. . .

(Yi[N] ? XN: 0)=>Si_N,

The shift operator 120_i operates when the preprocessing unit 150_i operates in the multiplication mode. The shift operator 120_i operates a function of transmitting signals (Xi<<0), (Xi<<1), . . . , and (Xi (N-1)), which result from shifting the first signal Xi by 0, 1, . . . , and N-1 bits, to the summer SUMi according to the bits Yi[1], Yi[2], . . . , and Yi[N] of the second signal Yi. Herein, the operation of the shift operator 120_i may be expressed in Verilog language as follows, for example.

(Yi[1] ? (Xi<<0): 0)=>Si_1,

(Yi[2] ? (Xi 1): 0)=>Si_2,

. . .

(Yi[N] ? (Xi<<(N-1)): 0)≥ Si_N,

The preprocessing unit 150_i operates the selection operator 110_i or the shift operator 120_i according to the operation mode selection signal SFi. For example, when SFi of 0 means the operation of the selection operator 110_i and SFi of 1 means the operation of the shift operator 120_i, SF1=0, SF2=0, and SFN=1 mean that the first preprocessing unit 150_1, the second preprocessing unit 150_2, and the N-th preprocessing unit 150_N operate the selection operator 110_1, the selection operator 110_2, and the shift operator 120_N, respectively.

The main processing part 200 includes the summers SUM1, SUM2, . . . , and SUMN. The i-th summer SUMi adds the transmitted signals Si_1, Si_2, . . . , and Si_N, and outputs the sum as the i-th output Mi. The operation of the main processing part 200 may be expressed in Verilog language as follows, for example.

S1_1+S1_2+S1_N=>M1,

S2_1+S2_2+S2_N=>M2,

. . .

SN_1+SN_2+ . . . SN_N=>MN,

The delay part 300 delays the first to N-th outputs M1, M2, . . . , and MN according to a clock signal CLK and outputs the results. To this end, the delay part 300 includes a plurality of delay units DU1, DU2, . . . , and DUN. The signals D1, D2, . . . , and DN output from the delay part 300 correspond to the first to N-th outputs M1, M2, . . . , and MN, respectively.

The selection part 400 selects signals among signals R1, R2, . . . , and RN transmitted from a memory (not shown) and the signals Di, D2, . . . , and DN output from the delay part 300 according to input control signals SI1, SI2, . . . , and SIN, and outputs the selected signals as the first signals Xi, X2, . . . , and XN. For example, as shown in the drawing, the first signal Xi may be a signal selected among the signal Ri transmitted from the memory and the signal Di output from the delay part 300 according to the input control signal SIi. As another example, the first signal Xi may be a signal selected among the signal Ri transmitted from the memory and the two signals D(i-i) and Di output from the delay part 300 according to the input control signal SIi. That is, the first signal Xi may be a signal selected according to the input control signal SIi, among the signal Ri transmitted from the memory, the delay part output signal Di corresponding to the i-th output Mi, and the delay part output signal D(i-1) corresponding to the i-l-th output M(i-1). The memory (not shown) may include a plurality of banks, for example. For example, the memory may include N banks, and the N banks may be connected to the N inputs {X1, Y1}, {X2, Y2}, . . . , and {XN, YN}, respectively. In addition, the memory may include 2*N banks, and N banks thereof may be connected to the N first signals X1, X2, . . . , and XN, respectively, and the remaining N banks may be connected to the N second signals Y1, Y2, . . . , and YN, respectively. For example, the memory may include N banks, and the N banks may be connected to the N signals {R1, Y1}, {R2, Y2}, . . . , and {RN, YN}, respectively. In addition, the memory may include 2*N banks, and N banks thereof may be connected to the N signals R1, R2, . . . , and RN, respectively, and the remaining N banks may be connected to the N second signals Y1, Y2, . . . , and YN, respectively.

The parallel processing device has the above-described configuration, thus performing various operations with one piece of hardware. For example, the parallel processing device may perform a partial sum operation. Herein, partial sum means summing all or some of the first signals Xi, X2, . . . , and XN. In order to perform the partial sum operation, the preprocessing part 100 operates in the summing mode. Herein, the i-th output Mi corresponds to the sum of signals selected among the first signals X1, X2, . . . , and XN according to the bits Yi [1], Yi [2], . . . , and Yi[N] of the second signal Yi. When N is 4 and the second signals Y1, Y2, Y3, and Y4 are binary numbers 1011, 1100, 0010, and 0111, the outputs M1, M2, M3, and M4 correspond to X4+X2+X1, X4+X3, X2, and X3+X2+X1, respectively. In this way, when the preprocessing part 100 operates in the summing mode, N partial sum operations may be performed simultaneously.

When the preprocessing part 100 operates in the summing mode, a displacement operation may also be performed. Herein, the displacement operation means changing positions in transmitting the first signal Xi as the output signals M1, M2, . . . , and MN. When N is 4 and the second signals Y1, Y2, Y3, and Y4 are binary numbers 1000, 0100, 0010, and 0001, the outputs M1, M2, M3, and M4 correspond to X4, X3, X2, and X1, respectively. Accordingly, the first signals X1, X2, X3, and X4 are transmitted as the outputs M1, M2, M3, and M4 with changed positions.

As described above, when the parallel processing device performs a partial sum operation and a displacement operation, data exchange between the processing units is facilitated. Herein, a concept is used in which the i-th processing unit includes the i-th preprocessing unit and the i-th summer. For example, the first processing unit (150_1 and SUM1) may receive the first signal X1, which is the first in order, as well as the first signals X2, . . . , and XN, which are the second to N-th in order, and may perform partial sum. In addition, the second processing unit (150_2 and SUM2) may receive, for example, the N-th first signal XN that is the first signal other than the first signal X2, which is the second in order.

For example, the parallel processing device may perform a multiplication operation. In order to perform the multiplication operation, the preprocessing part 100 operates in the multiplication mode. Herein, the i-th output Mi corresponds to the product Xi*Yi of the first signal Xi and the second signal Yi. When N is 4, the outputs M1, M2, M3, and M4 correspond to X1*Y1, X2*Y2, X3*Y3, and X4*Y4, respectively. In this way, when the preprocessing part 100 operates in the multiplication mode, N multiplications may be performed simultaneously.

When the preprocessing part 100 operates in the multiplication mode, a shift operation may be performed. When N is 4 and the second signals Y1, Y2, Y3, and Y4 are binary numbers 1000, 0100, 0010, and 0001, the outputs M1, M2, M3, and M4 correspond to (Y1<<3), (Y2<<2), (Y3<<1), and (Y4<<0), respectively.

The parallel processing device may perform various operations simultaneously. For example, when N is 4, the following operations may be performed simultaneously.

M1=X2+X3+X4 [partial sum operation]

M2=X1 [displacement operation]

M3=X3 * Y3 [multiplication operation]

M4=(X4<<2) [shift operation]

To this end, the selection signals SF1 and SF2 are set such that the first and second preprocessing units 150_1 and 150_2 are in the summing mode, and the selection signals SF3 and SF4 are set such that the third and fourth preprocessing units 150_3 and 150_4 are in the multiplication mode. In addition, in order to perform the partial sum operation as described above, Y1 is set to 1110. In order to perform the displacement operation as described above, Y2 is set to 0001. In order to perform the shift operation as described above, Y4 is set to 0100.

In addition, the parallel processing device may independently change the operation of the parallel processing device for each cycle by changing the selection signal SFi and the second signal Yi. For example, in the first cycle, as described above, M1, M2, M3, and M4 may perform the partial sum operation, the displacement operation, the multiplication operation, and the shift operation, respectively. Next, in the second cycle, M1, M2, M3, and M4 may perform the multiplication operation, the multiplication operation, the partial sum operation, and the partial sum operation as follows.

M1=X1 * Y1 [multiplication operation]

M2=X2 * Y2 [multiplication operation]

M3=X1+X2+X3+X4 [partial sum operation]

M4=X2+X4 [partial sum operation]

To this end, the selection signals SF1 and SF2 are set such that the first and second preprocessing units 150_1 and 150_2 are in the multiplication mode, and the selection signals SF3 and SF4 are set such that the third and fourth preprocessing units 150_3 and 150_4 are in the summing mode. In addition, in order to perform the partial sum operation as described above, Y3 and Y4 are set to 1111 and 1010, respectively.

In this way, the parallel processing device according to the first embodiment may perform N independent operations simultaneously, and may independently change N operations for each cycle. This may maximize the efficiency of the parallel processing device.

Assuming that there is a parallel processing device including a partial sum parallel processor for performing a plurality of partial sum operations, a displacement parallel processor for performing a plurality of displacement operations, a multiplication parallel processor for performing a plurality of multiplication operations, and a shift parallel processor for performing a plurality of shift operations, the multiplication parallel processor may be used 100% at the moment when many multiplication operations are required, but the usage of the partial sum parallel processor, the displacement parallel processor, and the shift parallel processor may be low. In addition, the partial sum parallel processor may be used 100% at the moment when many partial sum operations are required, but the usage of the displacement parallel processor, the multiplication parallel processor, and the shift parallel processor may be low.

Unlike this, the parallel processing device according to the first embodiment may change the operations performed by the preprocessing units 150_1, 150_2, . . . , and 150_N at every moment, thereby maximizing the usage of the parallel processing device. For example, by setting many of the preprocessing units 150_1, 150_2, . . . , and 150_N to perform multiplication operations and setting the remainings to perform other operations at the moment when many multiplication operations are required, most of the preprocessing units 150_1, 150_2, . . . , and 150_N are used. In addition, by setting many of the preprocessing units 150_1, 150_2, . . . , 150_N to perform partial sum operations and setting the remainings to perform other operations at the moment when many partial sum operations are required, most of the preprocessing units 150_1, 150_2, . . . , and 150_N are used.

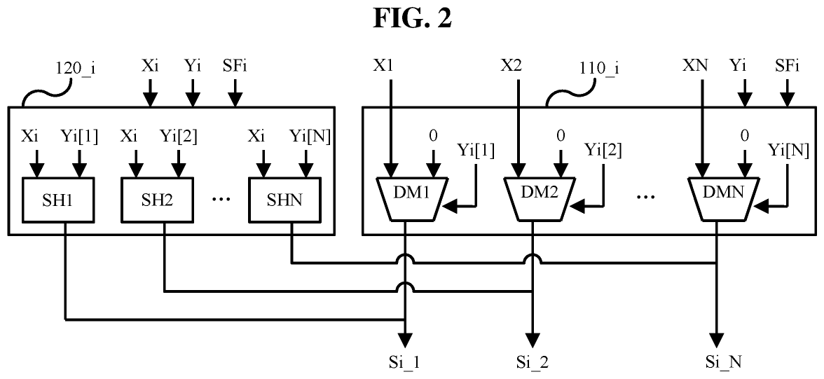

FIG. 2 is a diagram illustrating an example of an i-th preprocessing unit according to the first embodiment. Referring to FIG. 2, the preprocessing unit includes the selection operator 110_i and the shift operator 120_i.

The selection operator 110_i includes a plurality of demultiplexers DM1, DM2, and DMN. The plurality of demultiplexers DM1, DM2, . . . , and DMN respectively output signals selected among 0 and the plurality of first signals X1, X2, . . . , and XN according to the bits Yi[1], Yi[2], . . . , and Yi[N] of the second signal Yi. For example, the first demultiplexer DM1 outputs a signal selected among 0 and the first signal X1 according to the first bit Yi[1] of the second signal Yi. The second demultiplexer DM2 outputs a signal selected among 0 and the first signal X2 according to the second bit Yi[2] of the second signal Yi. The N-th demultiplexer DMN outputs a signal selected among 0 and the first signal XN according to the N-th bit Yi[N] of the second signal Yi.

The shift operator 120_i includes a plurality of shift units SH1, SH2, . . . , and SHN. The plurality of shift units SH1, SH2, . . . , and SHN respectively output signals selected among 0 and signals resulting from shifting the first signal Xi, according to the bits Yi[i], Yi[2], . . . , and Yi[N] of the second signal Yi. For example, the first shift unit SH1 outputs a signal selected among 0 and the signal (Xi<<0) resulting from shifting the first signal Xi by 0 bits, according to the first bit Yi[i] of the second signal Yi. The second shift unit SH2 outputs a signal selected among 0 and the signal (Xi<<1) resulting from shifting the first signal Xi by 1 bit, according to the second bit Yi[2] of the second signal Yi. The N-th shift unit SHN outputs a signal selected among 0 and the signal (Xi<<(N-1)) resulting from shifting the first signal Xi by (N-1) bits, according to the N-th bit Yi[N] of the second signal Yi.

According to the selection signal SFi, either the selection operator 110_i or the shift operator 120_i operates. For example, when the selection signal SFi is 0, the selection operator 110_i operates and the shift operator 120_i does not operate. Herein, the selection operator 110_i transmits the signals output from the demultiplexers DM1, DM2, . . . , and DMN as summer inputs Si_1, Si_2, . . . , and Si_N to the summer SUMi, and the shift operator 120_i outputs high impedance signals. In addition, when the selection signal SFi is 1, the selection operator 110_i does not operate and the shift operator 120_i operate. Herein, the selection operator 110_i outputs high impedance signals, and the shift operator 120_i transmits the signals output from the shift units SH1, SH2, . . . , and SHN as summer inputs Si_1, Si_2, . . . , and Si_N to the summer SUMi.

Unlike the drawing, additional demultiplexers may be added to select some of the outputs of the selection operator 110_i and the outputs of the shift operator 120_i according to the selection signal SFi. For example, when the selection signal SFi indicates the summing mode, the additional demultiplexers may transmit the outputs of the selection operator 110_i to the summer SUMi. When the selection signal SFi indicates the multiplication mode, the additional demultiplexers may transmit the outputs of the shift operator 120_i to the summer SUMi.

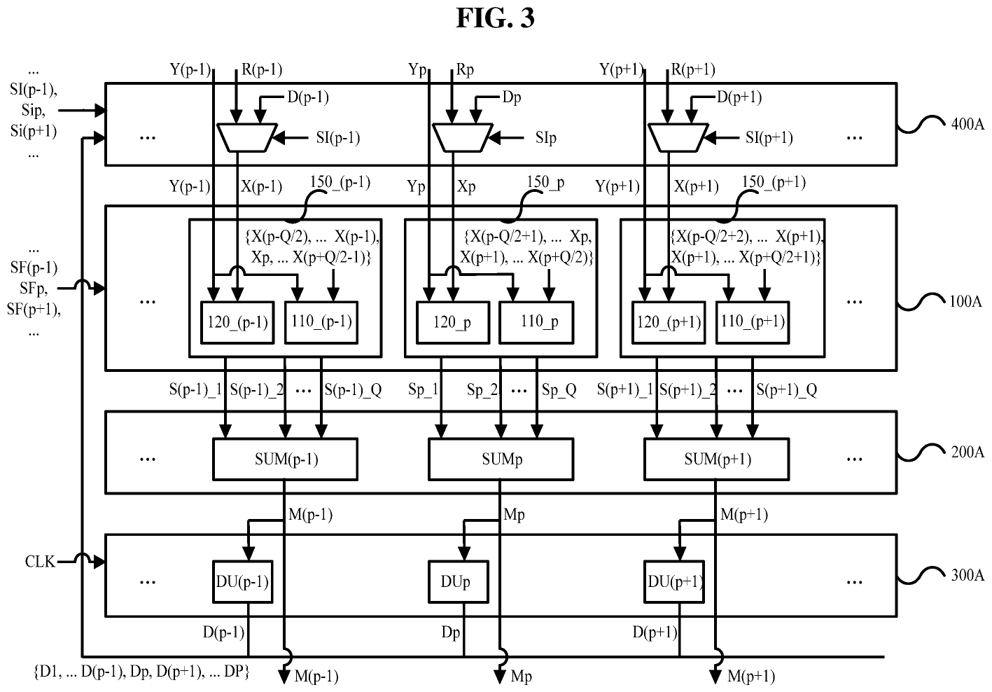

FIG. 3 is a diagram illustrating a parallel processing device according to a second embodiment. Referring to FIG. 3, the parallel processing device receives first to P-th inputs {X1, Y1}, . . . , {X(p-1), Y(p-1)}, {Xp, Yp}, {X(p+1), Y(p+1)}, . . . , and {XP, YP}, and outputs first to P-th outputs M1, . . . , M(p-1), Mp, M(p+1) . . . , and MP. Herein, P means a natural number of 4 or more, and for example, P may be 1024. In addition, p means a natural number that is equal to or greater than 1 and is equal to or less than P. The first to P-th inputs {X1, Y1}, . . . , {X(p-1), Y(p-1)}, {Xp, Yp}, {X(p+i), Y(p+1)}, . . . , and {XP, YP} include first signals X1, . . . , X(p-1), Xp, X(p+1), . . . , and XP and second signals Y1, . . . , Y(p-1), Yp, Y(p+1) . . . , and YP. The parallel processing device includes a preprocessing part 100A and a main processing part 200A. The parallel processing device may further include a delay part 300A and a selection part 400A.

The preprocessing part 100A includes a plurality of preprocessing units ( . . . 150_(p−1), 150_p, 150(p+1), . . . ). The plurality of preprocessing units ( . . . 150_(p−1), 150_p, 150(p+1),. include selection operators ( . . . 110_(p−1), 110_p, 110_(p+1),.. and shift operators ( . . . 120_(p−1), 120_p, 120_(p+1), . . . ). The preprocessing unit 150_p includes the selection operator 110_p and the shift operator 120_p.

The selection operator 110_p operates when the preprocessing unit 150_p operates in a summing mode. The selection operator 110_p performs a function of transmitting the first signal Xp corresponding to the preprocessing unit 150_p and the first signals (e.g., X(p−Q/2+1), . . . , X(p−1), X(p+1), . . . , and X(p+Q/2)) adjacent thereto to a summer SUMp according to the bits Yp[1], Yp[2], . . . , and Yp[Q] of the second signal Yp. Herein, Q means an even number of 4 or more, and for example, Q may be 32. In addition, q means a natural number that is equal to or greater than 1 and is equal to or less than Q. Herein, the operation of the selection operator 110_p may be expressed in Verilog language as follows, for example.

(Yp[1] ? X(p−Q/2+1): 0)=>Sp_1,

(Yp[2] ? X(p−Q/2+2): 0)=>Sp_2,

. . .

(Yp[Q] ? X(p+Q/2): 0)=>Sp_Q,

The shift operator 120_p operates when the preprocessing unit 150_p operates in a multiplication mode. The shift operator 120_p performs a function of transmitting signals (Xp<<0), (Xp<<1), . . . , and (Xp<<(Q-1)), which result from shifting the first signal Xp by 0, 1, . . . , and (Q-1) bits, to the summer SUMp according to the bits Yp [1], Yp[2], . . . , and Yp[Q] of the second signal Yp. Herein, the operation of the shift operator 120_p may be expressed in Verilog language as follows, for example.

(Yp[1] ? (Xp<<0): 0)=>Sp_1,

(Yp[2] ? (Xp<<1): 0)=>Sp_2,

. . .

(Yp[Q] ? (Xp<<(Q−1)): 0)=>Sp_Q,

The preprocessing unit 150_p operates the selection operator 110_p or the shift operator 120_p according to an operation mode selection signal SFp.

The main processing part 200A includes summers ( . . . SUM(p-1), SUMp, SUM(p+1), . . . ). The p-th summer SUMp adds the transmitted signals Sp_1, Sp_2, . . . , and Sp_Q, and outputs the sum as the p-th output Mp. The operation of the main processing part 200A may be expressed in Verilog language as follows, for example.

. . .

S(p−1)_1+S(p−1)_2+ . . . S(p−1)_Q=>M(p−1),

Sp_1+Sp_2+ . . . Sp_Q=>Mp,

S(p+1)_1+S(p+1)_2+ . . . S(p+1)_Q=>M(p+1),

. . .

The delay part 300A delays the outputs ( . . . M(p−1), Mp, M(p+1), . . . ) according to a clock signal CLK and outputs the results. To this end, the delay part 300A includes a plurality of delay units ( . . . DU(p−1), DUp, DU(p+1), . . . ). The signals ( . . . D(p−1), Dp, D(p+1), . . . ) output from the delay part 300A correspond to the outputs ( . . . M(p−1), Mp, M(p+1), . . . ), respectively.

The selection part 400A selects signals among signals ( . . . R(p−1), Rp, R(p+1), . . . ) transmitted from a memory (not shown) and the signals ( . . . D(p−1), Dp, D(p+1), . . . ) output from the delay part 300A according to input control signals ( . . . SI(p−1), SIp, SI(p+1), . . . ), and outputs the selected signals as the first signals ( . . . X(p−1), Xp, X(p+1), . . . ). For example, the memory includes P banks, and the P banks may be connected to the P inputs {X1, Y1}, {X2, Y2}, . . . , and {XP, YP}, respectively. In addition, the memory may include 2P banks, and P banks thereof may be connected to the P first signals X1, X2, . . . , and XP, respectively, and the remaining P banks may be connected to the P second signals Y1, Y2, . . . , and YP, respectively. For example, the memory includes P banks, and the P banks may be connected to the P signals {R1, Y1}, {R2, Y2}, . . . , and {RP, YP}, respectively. In addition, the memory may include 2P banks, and P banks thereof may be connected to the P signals R1, R2, . . . , and RP, respectively, and the remaining P banks may be connected to the P second signals Yi, Y2, . . . , and YP, respectively.

1. A parallel processing device configured to receive first to N-th inputs ({X1, Y1}, {X2, Y2}, . . . , and {XN, YN}) and output first to N-th outputs (M1, M2, . . . , and MN), wherein the first to N-th inputs ({X1, Y1}, {X2, Y2}, . . . , and {XN, YN}) include a plurality of first signals (X1, X2, . . . , and XN) and a plurality of second signals (Y1, Y2, . . . , and YN) and the N is a natural number of 4 or more, the parallel processing device comprising:
a preprocessing part configured to transmit an i-th first signal (Xi) to each summer (SUM1, SUM2, . . . , and SUMN) according to i-th bits (Y1[i], Y2[i], . . . , and YN[i]) of the plurality of second signals (Y1, Y2, . . . , and YN) when operating in a summing mode, or respectively transmit signals ((X1<<(i-1)), (X2<<(i-1)), . . . , and (XN<<(i-1))) resulting from shifting the first signals (X1, X2, . . . , and XN) by (i-1) bits to the summers (SUM1, SUM2, . . . , and SUMN) according to the i-th bits (Y1[i], Y2[i], . . . , and YN[i]) of the second signals (Y1, Y2, . . . , and YN) when operating in a multiplication mode, wherein the i is a natural number that is equal to or greater than 1 and is equal to or less than the N; and
a main processing part comprising the summers (SUM1, SUM2, . . . , and SUMN) configured to output the first to N-th outputs (M1, M2, . . . , and MN), wherein each of the summers (SUM1, SUM2, . . . , and SUMN) adds the transmitted signals.

2. The parallel processing device of claim 1, wherein the preprocessing part comprises:
a selection operator configured to transmit each of the first signals (X1, X2, . . . , and XN) to an i-th summer (SUMi) according to bits (Yi[1], Yi[2], . . . , and Yi[N]) of an i-th second signal (Yi) when operating in the summing mode; and
a shift operator configured to transmit signals ((Xi<<O), (Xi<<1), . . . , and (Xi<<(N-1))) resulting from shifting the i-th first signal (Xi) by 0, 1, . . . , and (N-1) bits to the i-th summer (SUMi) according to the bits (Yi[i], Yi[2], . . . , and Yi[N]) of the i-th second signal (Yi) when operating in a shift mode.

3. The parallel processing device of claim 1, further comprising:
a delay part configured to delay the outputs (M1, M2, . . . , and MN) according to a clock signal and output results of delay; and
a selection part configured to output, as the first signals (X1, X2, . . . , and XN), signals selected among signals (R1, R2, . . . , and RN) transmitted from a memory and signals (D1, D2, . . . , and DN) output from the delay part, according to input control signals respectively.

4. The parallel processing device of claim 1, wherein when the preprocessing part operates in the summing mode, an i-th output (Mi) corresponds to a sum of signals selected among the first signals (X1, X2, . . . , and XN) according to bits (Yi[1], Yi[2], . . . , and Yi[N]) of an i-th second signal (Yi).

5. The parallel processing device of claim 1, wherein when the preprocessing part operates in the multiplication mode, an i-th output (Mi) corresponds to a product (Xi * Yi) of the i-th first signal (Xi) and an i-th second signal (Yi).

6. A parallel processing device, comprising:
a preprocessing part comprising preprocessing units; and
a main processing part comprising summers,
wherein each of the preprocessing units comprises a selection operator and a shift operator,
the selection operator is configured to operate when corresponding one of the preprocessing units operates in a summing mode, and configured to perform a function of transmitting first signals to corresponding one of the summers according to bits of corresponding one of second signals respectively, and
the shift operator is configured to operate when the corresponding preprocessing unit operates in a multiplication mode, and configured to transmit signals resulting from shifting corresponding one of the first signals to the corresponding summer according to the bits respectively.

7. The parallel processing device of claim 6, wherein the selection operator comprises demultiplexers, and the demultiplexers are configured to respectively output signals selected among the first signals and 0 according to the bits.

8. The parallel processing device of claim 6, wherein the shift operator comprises shift units, and the shift units are configured to respectively output signals selected among the signals resulting from shifting and 0, according to the bits.

9. The parallel processing device of claim 6, further comprising:
a delay part configured to delay outputs of the summers according to a clock signal and output results of delay; and
a selection part configured to respectively output, as the first signals, signals selected among signals transmitted from a memory and signals output from the delay part, according to input control signals respectively.

10. The parallel processing device of claim 6, wherein when the corresponding preprocessing unit operates in the summing mode, an output of the corresponding summer corresponds to a sum of first signals selected among the first signals according to the bits of the corresponding second signal.

11. The parallel processing device of claim 6, wherein when the corresponding preprocessing unit operates in the multiplication mode, an output of the corresponding summer corresponds to a product of the corresponding first signal and the corresponding second signal.

12. The parallel processing device of claim 6, wherein some of the preprocessing units operate in the summing mode, and simultaneously, others operate in the multiplication mode.

13. The parallel processing device of claim 12, wherein which ones of the preprocessing units operate in the summing mode and which other ones of the preprocessing units operate in the multiplication mode change over time.

14. The parallel processing device of claim 6, wherein the corresponding preprocessing unit operates in either the summing mode or the multiplication mode according to corresponding one of a plurality of selection signals.

15. A parallel processing device, comprising:
a preprocessing part comprising preprocessing units; and
a main processing part comprising summers,
wherein each of the preprocessing units comprises a selection operator and a shift operator,
the selection operator is configured to operate when corresponding one of the preprocessing units operates in a summing mode, and configured to perform a function of transmitting corresponding some first signals of first signals to corresponding one of the summers according to bits of corresponding one of second signals respectively, and
the shift operator is configured to operate when the corresponding preprocessing unit operates in a multiplication mode, and configured to transmit signals resulting from shifting corresponding one of the first signals to the corresponding summer according to the bits respectively.

16. The parallel processing device of claim 15, wherein the corresponding some first signals include the corresponding first signal and first signals adjacent to the corresponding first signal.

17. The parallel processing device of claim 15, further comprising:
a delay part configured to delay outputs of the summers according to a clock signal and output results of delay; and
a selection part configured to output, as the first signals, signals selected among signals transmitted from a memory and signals output from the delay part, according to input control signals respectively.

18. The parallel processing device of claim 15, wherein when the corresponding preprocessing unit operates in the summing mode, an output of the corresponding summer corresponds to a sum of signals selected among the corresponding some first signals according to the bits.

19. The parallel processing device of claim 15, wherein when the corresponding preprocessing unit operates in the multiplication mode, an output of the corresponding summer corresponds to a product of the corresponding first signal and the corresponding second signal.

20. The parallel processing device of claim 15, wherein some of the preprocessing units operate in the summing mode, and simultaneously, others operate in the multiplication mode.

21. The parallel processing device of claim 20, wherein which ones of the preprocessing units operate in the summing mode and which other ones of the preprocessing units operate in the multiplication mode change over time.

22. The parallel processing device of claim 15, wherein the corresponding preprocessing unit operates in either the summing mode or the multiplication mode according to corresponding one of a plurality of selection signals.
